(19) United States
(12) Patent Application Publication
(10) Pub. No.: US 2006/0196117 A1
(43) Pub. Date: Sep. 7, 2006

(54) Pellet of bulbous plants, a method of pelletization and a cultivation method of plants using the same

(76) Inventor: Seung-Hyun Kim, Wonju-si (KR)

Correspondence Address: BIRCH STEWART KOLASCH & BIRCH, PO BOX 747, FALLS CHURCH, VA, 22040-0747, US

(21) Appl. No.: 10/532,713

(22) PCT Filed: Sep. 16, 2003
(86) PCT No.: PCT/KR03/01891

§ 371 Date: Apr. 27, 2005

(30) Foreign Application Priority Data
Oct. 28, 2002 (KR) 10-2002-0065847

(51) Int. Cl. A01G 9/02

(52) U.S. Cl. 47/65.7

(57) ABSTRACT

The present invention relates to a pelletization method of bulbous plants that involves the mixing of fertilizer, plant growth regulator, bactericide and insecticide with peatmoss, compressing and forming a lid and an entity from the mixture, inserting the bulbous plants in the entity after drying the compressed mixture, covering them with the dried lid and compressing them to obtain the resulting pellet with the bulbous plants. The present invention makes it possible to create a pellet of bulbous plants that has excellent growth after emergence of leaf by preventing the physiological reaction of the bulb upon removal of water within a pellet. The pellet prepared by the pelletization method according to the present invention can also be made into be suited to bulbous plants for planting in size and shape and it is no longer necessary to cover with earth again after planting the bulb in a soil surface.

### TECHNICAL FIELD

The present invention relates to a pellet of bulbous plants, a method for preparing pellets of bulbous plants and a cultivation method for plants that uses the same the bulbous plants pellets. In particularly, it relates to a pelletization method for bulbous plants wherein a lid and an entity are formed using peatmoss, the bulbous plants are inserted in a dry entity and the lid is covered with them, the pellet of bulbous plants prepared by said method and a cultivation method for plants that the bulbous plants pellets are sowed in a soil surface.

### BACKGROUND ART

The art of cultivating and sowing plant seeds has been significantly improved through in-depth research. However, there are still problems that need to be solved. Plant cultivation, which is comprised of several steps, such as raising the seedling, sowing, using fertilizers and controlling noxious insects, requires significant amounts of time, labor and money. In addition, it requires scientific and experiential knowledge of the treatment of plant seeds.

Peatmoss, which is often used in the field of agriculture, is an organic material composed of piles of rotten reeds from swamps or marshes in cold regions. Peatmoss has 15 times more moisture absorption than its dry condition and it has excellent aeration. In addition, it is light and has no side effects such as chemical reactions with fertilizers, so it is generally used in the production and sowing of seedlings.

Plant seed pellets are prepared by coating the surface of the plant seed with a mixture of nutrients to promote the germination and growth of the plant seed. The object of pelletization is to enlarge the micro-seed for the mechanization and protect from harmful insects or bacteria to promote the germination of the seedling. At present, plant seed pellets are generally prepared by coating the surface of the plant seed with several treated materials by glues. Because the materials used in the pelletization do not function as soil, it is still necessary to cover the seed with earth again after sowing. Thus, plant seed pellets prepared through this method are uneconomical and ineffective. On the other hand, if peatmoss is used as the material for pelletization, it reduces the time and effort necessary to cover the pellet with soil again because peatmoss can function as soil. However, when water is added in the pelletization process, it is absorbed into the seed and expands the germ and endosperm until the seed coat explodes and germinates. Drying during the process of storage after the occurrence of this physiological activation presents a physiological impediment that affects the seed's germination after sowing, and as a result, the germination rate drops. Therefore, the removal of water is an important technical consideration in the pelletization process using peatmoss.

To solve the aforementioned problem, a method has been used wherein the surface of the plant seed is coated with materials composed of mud, phosphate powder, lime powder and water-soluble Arabic gum, which are glued in a mixture and dried. However, this method cannot be used for all kinds of seeds, especially bulbous plants, because the materials do not react well to fertilizers, plant growth regulators, bactericides and insecticides.

The present invention relates to a pelletization method for bulbous plants and the bulbous plants pellets, which were not tried before. In order to solve the problem of removing water from the pellet, the present invention prepared a bulbous plants pellet by forming a mixture of peatmoss, fertilizer, plant growth regulator and others by dividing it into a lid and an entity to insert bulbous plants in that, inserting the bulbous plants into the entity after drying the formed mixture, covering them with the dried lid and compressing. Accordingly, the objective of the present invention is to provide the pelletization method for bulbous plants. Another objective of the present invention is to provide the bulbous plants pellets obtained by said pelletization method. A further objective of the present invention is to provide the cultivation method for plant using said bulbous plants pellets.

### DESCRIPTION OF THE INVENTION

The present invention is achieved through the following method: preparing a bulbous plants pellets by adding various materials; sowing the bulbous plants pellets using various methods; and evaluating the effectiveness of the bulbous plants pellet by investigation the leaf emergence rate of bulbous plants, the number of leaf emergence every day after planting and the condition of growth.

The pelletization method is comprised of the following steps:

a) mixing one or more materials selected from a group consisting of fertilizer, plant growth regulator, bactericide and insecticide with peatmoss using water-soluble glue;

b) compressing and forming a pellet by dividing it into a lid and an entity to insert bulbous plants in that from the mixture prepared in the Step a);

c) drying the pellet formed Step b); and

d) inserting the bulbous plants in the entity, covering them with said dried lid and compressing them to produce the resulting pellet with an inserted bulbous plants.

The steps in the pelletization method proposed in this present invention are described in detail below.

Step 1

One of more materials are selected from a group consisting of a fertilizer, plant growth regulator, bactericide and insecticide, then mixed with peatmoss as demands, and add water-soluble glue in the mixture. The fertilizer is comprised of N, P and K ingredients. The plant growth regulator is comprised of plant growth hormone, typically GA and NAA. The water-soluble glue should preferably be vegetative cement or acryl cement The peatmoss absorbs the water from the mixture and can be pressed under wet conditions.

Step 2

The mixture prepared in the Step 1 is compressed to form a pellet by dividing it into a lid and an entity to insert bulbous plants in that. The size and shape of the pellet depends on those of bulbous plants to be inserted later. The wet peatmoss and water-soluble glue in the Step 1 make said mixture to be compressed and formed. FIG. 6 shows the process of pelletization as presented in the present invention.

Step 3

The formed and compressed pellet obtained from Step 2 is dried at 25˜80° C. At this time, the water content of the mixture should preferably be 15˜25% by weight. The preferred drying method is the hot wind drying method for mass production or the natural drying method. Since the bulbous plants will be inserted after dying, this prevents the leaf emergence of bulbous plants from the water absorbed by the peatmoss. Therefore, the problem that exists in previous methods, which was earlier described, does not occur.

Step 4

Bulbous plants are inserted in the entity dried in the Step 3, they are covered with the lid dried in the Step 3 and compressed and sealed.

The pelletization method for bulbous plants presented in the present invention does not undergo chemical reactions during the mixing of the various materials, such as fertilizer, plant growth regulator, bactericide and insecticide, with peatmoss. The material used is free and the process is convenient. In addition, the bulbous plants pellet does not exhibit physiological reaction to water. Furthermore, the bulbous plants pellet, which is sown and absorbs water, has 3 or 4 times more volume compared to its dried condition and can be used in large-scale cultivation. Because peatmoss functions as a soil, the pellet can be sown in a soil surface without being covered up again with soil.

TABLE 1
Comparison of previous pelletization method with
pelletization method of the present invention

| | Previous pelletization | Pelletization method of |
|---|---|---|
| | methods | the present invention |
| Target | Mainly micro-plant | All kinds of plant seeds |
| | seeds | and bulbous plants |
| Purpose | Enlargement and | Possibility of |
| | uniformity for | enlargement, uniformity, |
| | mechanization of | simplicity of cultivation |
| | sowing | and aerial sowing. |
| Material | Mud, phosphate powder, | Peatmoss |
| | lime powder, water- | |
| | soluble Arabic gum | |
| Production | 1) The seed is | 1) Compression and |
| method and | prepared as a pellet | formation a pellet by |
| characteristic | by coating its surface | dividing it into a lid and |
| | with several materials | an entity using a mixture |
| | using glue. | of chemicals and peatmoss, |
| | 2) Expensive | drying them, inserting the |
| | manufacturing | bulbous plants in it, |
| | equipment is needed. | covering them with the |
| | | dried lid, compressing and |
| | | sealing them. |
| | | 2) Preparation is very |
| | | easy, simple manufacturing |
| | | equipment is needed and it |
| | | is possible to make it by |
| | | hand. |
| Water drying | In the process of | The problem with |
| | coating the seed with | physiological activation |
| | various materials, | does not occur because |
| | wind or heat is used | of the compression and |
| | for drying, and the | formation of the lid and |
| | physiological | the entity using peatmoss |
| | activation happens | and the insertion of the |
| | because of water | bulbous plants after |
| | absorption into the | drying. |
| | seed during the | |
| | preparation process. | |
| Addition | It is possible to mix | Ingredients necessary for |
| | materials comprising | the growth of the bulbous |
| | of fertilizer, plant | plants, such as |
| | growth regulator, | fertilizer, plant growth |
| | bactericide, and | regulator, bactericide, |
| | insecticide, but | and insecticide, are |
| | chemical reactions may | easily mixed and there are |
| | occur to create an | no inhibition effects. |
| | inhibition effect. | |
| Physical and | 1) Aeration and | 1) Aeration and moisture |
| chemical | moisture holding are | holding is excellent. |
| characteristic | not good. | 2) Chemical inhibition |
| | 2) The selection of | reaction does not happen |
| | material requires | completely. |
| | caution because there | |
| | is a possibility of an | |
| | incidental chemical | |
| | reaction among the | |
| | coating materials. | |
| Sowing method | It is necessary to sow | It is possible to sow seed |
| | seed in the soil | in the soil surface as |
| | because the | well as in the soil |
| | pelletization | because the peatmoss |
| | materials do not | functions as a soil. |
| | function as a soil. | |
| Hereafter | Correction of defects | It is possible to apply |
| possibility | is required according | widely to all kinds of |
| | to the materials and | plant seed and bulbous |
| | the applied plant | plants. It can also be |
| | seed. | practiced as soon as |
| | | possible. |

### BRIEF DESCRIPTION OF THE DRAWINGS

FIG. 1a shows the leaf emergence rate according to various pelletization methods and planting methods (experimental examples 1˜8) in Lilium tigrinum main bud.

FIG. 2 shows the germination according to various pelletization methods and planting methods (experimental examples 1˜8) in potato.

FIG. 3a shows the change in germination population after planting according to planting methods in Lilium tigrinum main bud, which was not pelletized;

FIG. 3b shows the change in germination population after planting according to planting methods in Lilium tigrinum main bud, which was treated with only fertilizer.

FIG. 3c shows the change in germination population after planting according to planting methods in Lilium tigrinum main bud, which was treated with fertilizer and GA.

FIG. 3d shows the change in germination population after planting according to planting methods in Lilium tigrinum main bud, which was treated with fertilizer and NAA.

FIG. 4a shows the change in leaf emergence population after planting according to planting methods in potato, which was not pelletized.

FIG. 4b shows the change in leaf emergence population after planting according to planting methods in potato, which was treated with only fertilizer.

FIG. 4c shows the change in leaf emergence population after planting according to planting methods in potato, which was treated with fertilizer and GA.

FIG. 4d shows the change in leaf emergence population after planting according to planting methods in potato, which was treated with fertilizer and NAA.

FIG. 5 is a photograph compared the pelletization process of plant seed with that of bulbous plants.

FIG. 6 shows the pelletization process of bulbous plants.

FIG. 7 shows the growth states in Lilium tigrinum main bud, which was not pelletized and in the pelletized Lilium tigrinum main bud in two months after sowing.

FIG. 8 shows the growth state in the pelletized Lilium tigrinum main bud in the sowing state of the soil surface.

FIG. 9 is a photograph of Lilium tigrinum main bud, which was pelletized and grown.

FIG. 10 shows the growth states in the potato that was not pelletized and in the pelletized potato in 100 days after planting.

FIG. 11 shows the growth state in the pelletized potato in the sowing state of the soil surface.

FIG. 12 shows the new tuber in the pelletized potato.

### DETAILED DESCRIPTION OF THE PREFERRED EMBODIMENTS

To compare and analyze the effects of pelletization using peatmoss, fertilizer and plant growth regulator, the pellets of Lilium tigrinum main bud and potato were prepared through the pelletization method described above. Then the growth states, comprising of the leaf emergence rate, the number of leaf emergence every day after planting, the plant height, the number of leaf, the leaf length, tuber number and tuber weight, were studied and statistically analyzed.

Experiment of the present invention was carried out from April 2002 to June 2002. The planting was conducted in a rectangle plastic cut-age box using clay sand. Intermediate fertilizer was not applied at all, and only watering was carried out as demanded. The said process was carried out three times repeatedly on one hundred of Lilium tigrinum main bud and potato.

Also, the planting of the prepared pellets were conducted in two sowing methods; one is a sowing method wherein it was not necessary to cover with earth after planting in the soil surface and the other is a sowing method wherein it was necessary to cover with earth.

The shape of the pellet depends on the size and shape of the bulbous plants. However, the pellets in the examples below were made in a spherical shape for the convenience of the experiment. The pelletization treatment and planting method were carried out as follows.

### EXAMPLE 1

Lilium tigrinum main bud and potato were not pelletized and planted using the method of planting in a soil surface.

### EXAMPLE 2

Pellets, which were prepared by adding fertilizer ingredients consisting of 300 mg/L of N, 200 mg/L of P and 400 mg/L of K to peatmoss, adjusting pH to 5.8, adding a water-soluble glue, compressing and forming a lid and an entity and inserting Lilium tigrinum main bud and potato in the entity, were planted using the method of planting in the soil surface.

### EXAMPLE 3

Pellets, which were prepared by adding Fertilizer ingredients consisting of 300 mg/L of N, 200 mg/L of P and 400 mg/L of K and 300 ppm of GA to peatmoss, adjusting pH to 5.8, adding a water-soluble glue, compressing and forming a lid and an entity and inserting Lilium tigrinum main bud and potato in the entity, were planted using the method of planting in the soil surface.

### EXAMPLE 4

Pellets, which were prepared by adding Fertilizer ingredients consisting of 300 mg/L of N, 200 mg/L of P and 400 mg/L of K and 300 ppm of NAA to peatmoss, adjusting pH to 5.8, adding a water-soluble glue, compressing and forming a lid and an entity and inserting Lilium tigrinum main bud and potato in the entity, were planted using the method of planting in the soil surface.

### EXAMPLE 5

Lilium tigrinum main bud and potato were not pelletized and covered with earth after planting (sown in the soil).

### EXAMPLE 6

Pellets, which were prepared by adding fertilizer ingredients consisting of 300 mg/L of N, 200 mg/L of P and 400 mg/L of K to peatmoss, adjusting pH to 5.8, adding a water-soluble glue, compressing and forming a lid and an entity, inserting Lilium tigrinum main bud and potato in the entity, were covered with earth after planting (sown in the soil).

### EXAMPLE 7

Pellets, which were prepared by adding fertilizer ingredients consisting of 300 mg/L of N, 200 mg/L of P and 400 mg/L of K and 300 ppm of GA to peatmoss, adjusting pH to 5.8, adding a water-soluble glue, compressing and forming a lid and an entity, inserting Lilium tigrinum main bud and potato in the entity, were covered with earth after planting (sown in the soil).

### EXAMPLE 8

Pellets, which were prepared by adding fertilizer ingredients consisting of 300 mg/L of N, 200 mg/L of P and 400 mg/L of K and 300 ppm of NAA to peatmoss, adjusting pH to 5.8, adding a water-soluble glue, compressing and forming a lid and an entity, inserting Lilium tigrinum main bud and potato in the entity, were covered with earth after planting (sown in the soil).

TABLE 2
Preparation of pellets according to examples 1˜8

| | | Plant | | | |
|---|---|---|---|---|---|
| | Fertilizer | growth | | | Planting |
| Example | (mg/L) | regulator | Peatmoss | pH | method |
| 1 | No | No | No | 5.8 | Planting |
| | | | | | seed in the |
| | | | | | soil surface |
| 2 | N; 300 | No¹⁾ | Compressing | 5.8 | Planting |
| | P; 200 | | and forming | | seed in the |
| | K; 400 | | a lid and an | | soil surface |
| | | | entity | | |
| 3 | N; 300 | GA²⁾ | Compressing | 5.8 | Planting |
| | P; 200 | 300 ppm | and forming | | seed in the |
| | K; 400 | | a lid and an | | soil surface |
| | | | entity | | |
| 4 | N; 300 | NAA³⁾ | Compressing | 5.8 | Planting |
| | P; 200 | 300 ppm | and forming | | seed in the |
| | K; 400 | | a lid and an | | soil surface |
| | | | entity | | |
| 5 | No | No | No | 5.8 | Covering |
| | | | | | with earth |
| | | | | | after |
| | | | | | planting |
| 6 | N; 300 | No | Compressing | 5.8 | Covering |
| | P; 200 | | and forming | | with earth |
| | K; 400 | | a lid and an | | after |
| | | | entity | | planting |
| 7 | N; 300 | GA | Compressing | 5.8 | Covering |
| | P; 200 | 300 ppm | and forming | | with earth |
| | K; 400 | | a lid and an | | after |
| | | | entity | | planting |
| 8 | N; 300 | NAA | Compressing | 5.8 | Covering |
| | P; 200 | 300 ppm | and forming | | with earth |
| | K; 400 | | a lid and an | | after |
| | | | entity | | planting |

[Footnote]
¹⁾ No; no pelletization
²⁾ GA; Giberellin
³⁾ NAA; Naphthalene acetic acid

TABLE 3
Growth differences in the pellets of Lilium tigrinum main
bud treated according to the methods in examples 1˜8

| | | Leaf | Leaf | Plant | Root |
|---|---|---|---|---|---|
| | No. of | length | width | height | length |
| Example | leaves | (cm) | (cm) | (cm) | (cm) |
| 1 | 0.58 c | 6.04 c | 0.42 c | 4.36 c | 0.48 c |
| 2 | 1.09 a | 14.09 a | 1.04 a | 8.05 a | 1.11 a |
| 3 | 0.81 b | 10.71 b | 0.77 b | 6.58 b | 0.82 b |
| 4 | 0.53 cd | 5.72 c | 0.42 c | 2.81 d | 0.32 d |
| 5 | 0.45 de | 5.72 c | 0.43 c | 3.11 d | 0.48 c |
| 6 | 0.38 e | 6.17 c | 0.42 c | 2.88 d | 0.51 c |
| 7 | 0.77 b | 1.16 d | 0.06 d | 0.48 e | 0.08 e |
| 8 | 0.00 f | 0.00 d | 0.00 d | 0.00 e | 0.00 f |

[Footnote]
¹⁾ Mean separation within columns by Duncan's multiple range test at p = 0.05.

TABLE 4
Growth differences in the pellets of potato treated
according to the methods in examples 1˜8

| | | | Plant | | Tuber | Total |
|---|---|---|---|---|---|---|
| Exam- | No. of | No. of | height | Tuber | Weight | Weight |
| ple | leaves | stems | (cm) | number | (g) | (g) |
| 1 | 12.31 e | 1.73 e | 13.23 e | 3.06 d | 21.32 f | 57.63 f |
| 2 | 24.50 c | 2.65 c | 42.57 c | 4.80 bc | 109.78 c | 203.28 bc |
| 3 | 35.33 ab | 3.72 ab | 56.65 b | 6.26 a | 141.51 a | 253.71 a |
| 4 | 16.82 d | 2.01 d | 15.7 e | 3.81 c | 45.33 e | 153.65 e |
| 5 | 25.07 c | 2.71 c | 22.06 d | 4.11 c | 98.37 c | 199.07 bc |
| 6 | 33.50 b | 3.51 b | 45.31 c | 5.41 b | 120.17 b | 212.81 b |
| 7 | 38.27 a | 4.05 a | 62.07 a | 7.02 a | 156.22 a | 287.54 a |
| 8 | 17.43 d | 2.13 d | 20.60 d | 3.90 c | 90.66 d | 181.35 d |

[Footnote]
¹⁾ Mean separation within columns by Duncan's multiple range test at p = 0.05.

The effects of Lilium tigrinum main bud and potato pellets prepared according to the present invention are as follows:

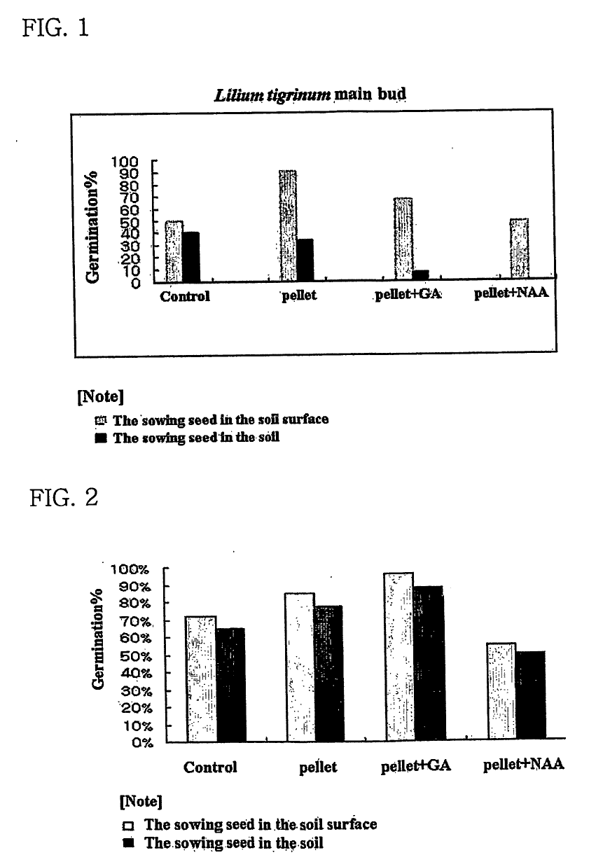

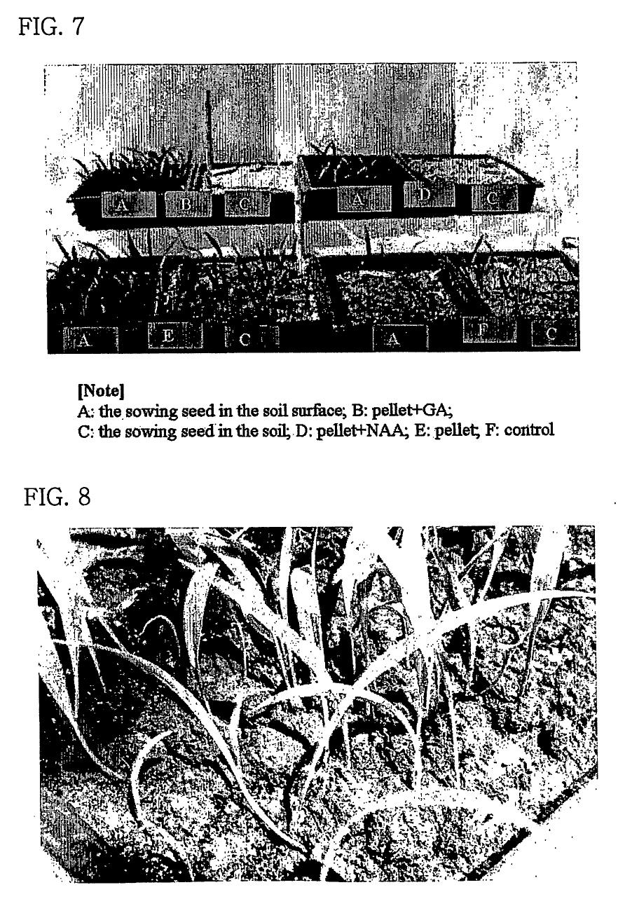

The pelletization treatment of Lilium tigrinum main bud and potato resulted in far better growth than those in the control group in terms of number of leaves, leaf length, leaf width, plant height, root length, tuber number, tuber weight and total weight (Table 3, 4). In addition, the pelletized Lilium tigrinum main bud (FIG. 1, FIG. 7) and the potato treated with pellet and GA (FIG. 2, FIG. 10) showed excellent leaf emergence rate. The pelletization treatment improved the growth state of the plant seeds after germination, but the growth state of those in the control group were poor. It is believed that the reason for this is because the peatmoss, which is light and has an excellent aeration, facilitates the supply of oxygen necessary for germination. In addition, the water potential of peatmoss is more than 60% of its total volume, which sufficiently wets the bulbous plants upon watering and promote the supply of nutrients through the absorption of the mixed fertilizer.

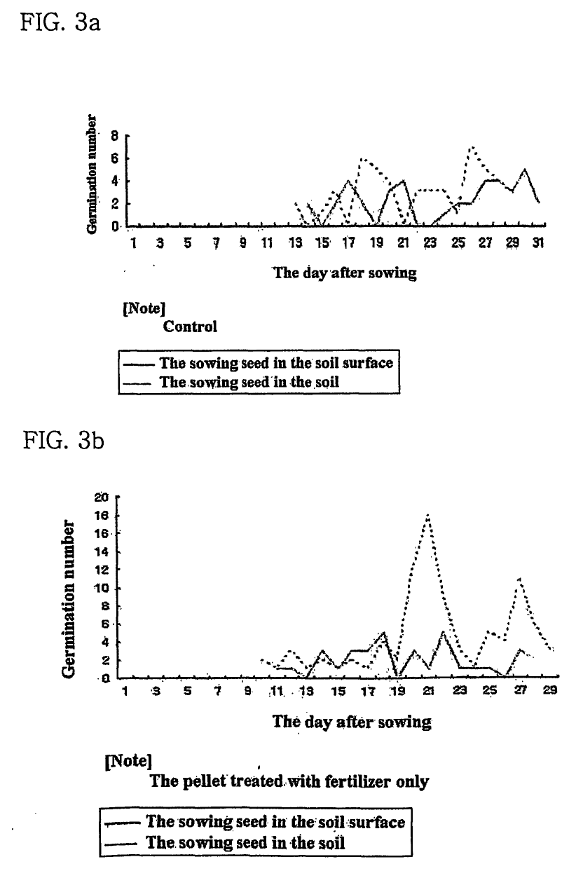

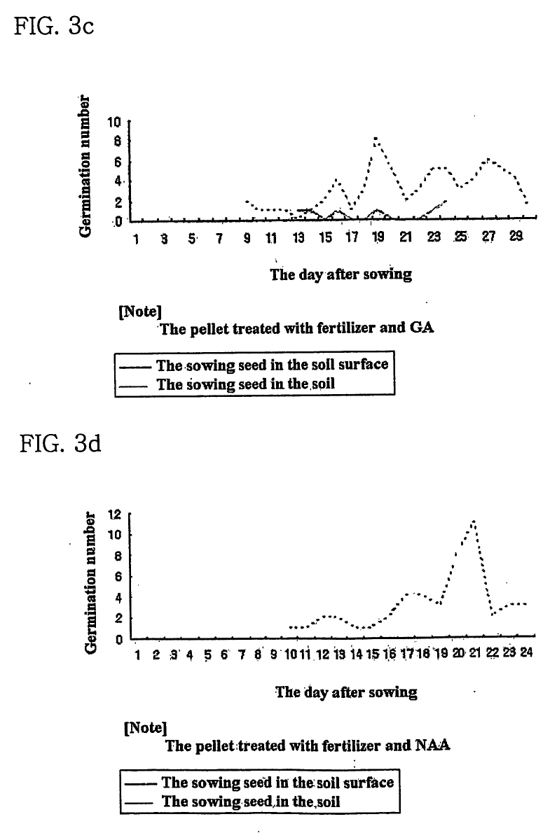

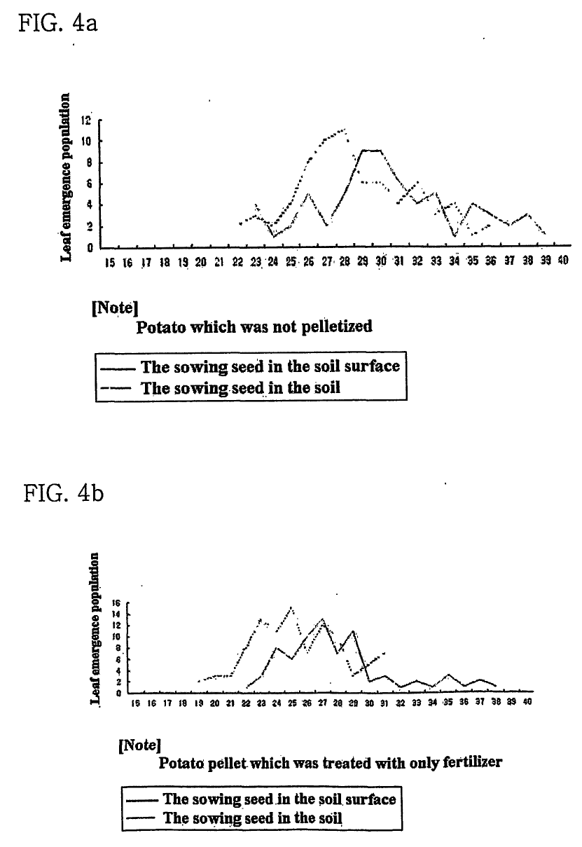

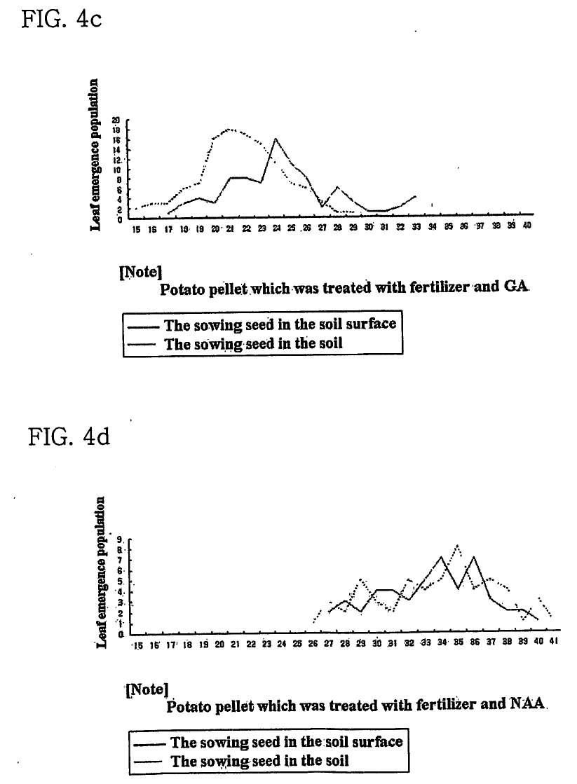

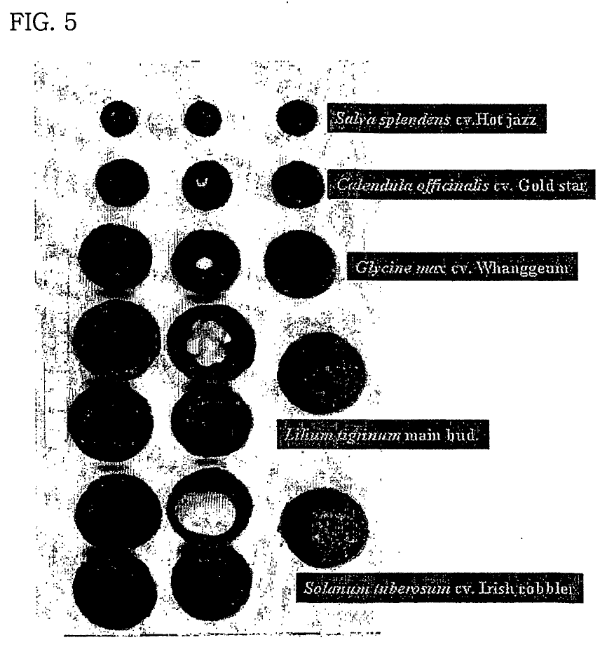

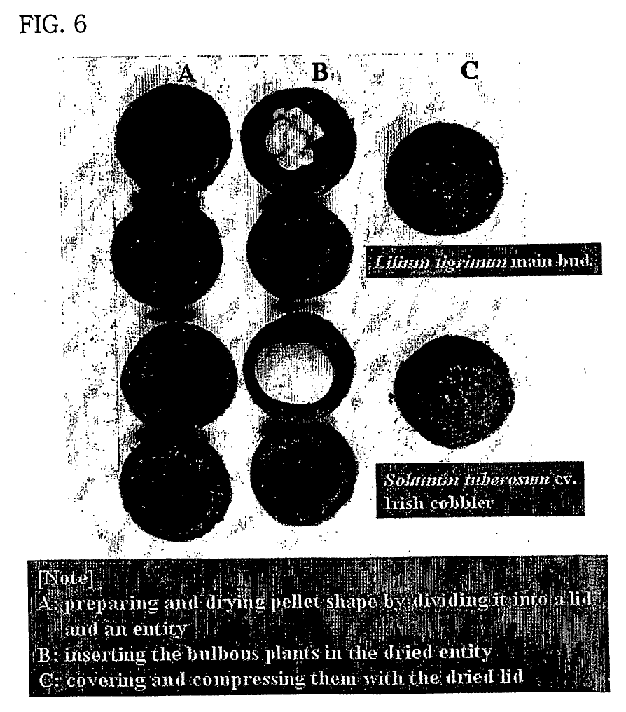

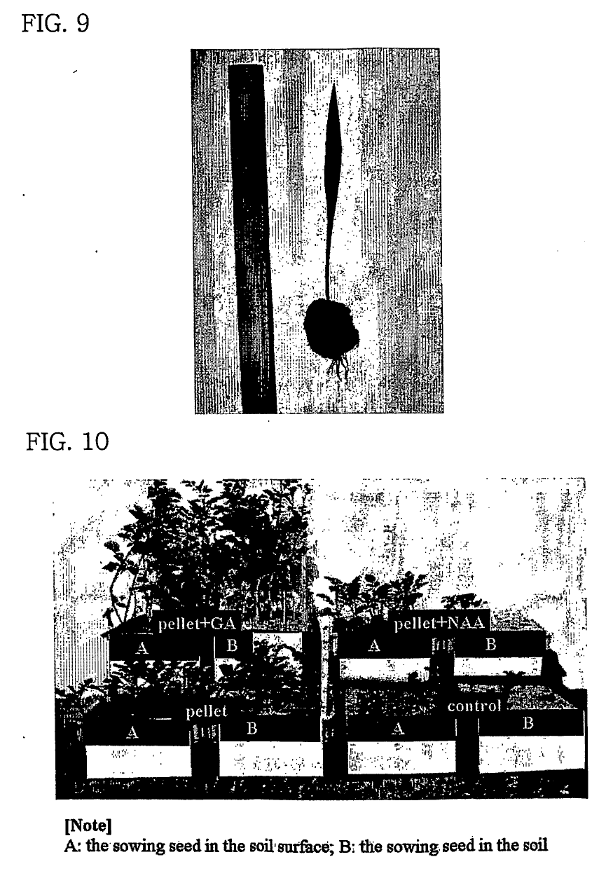

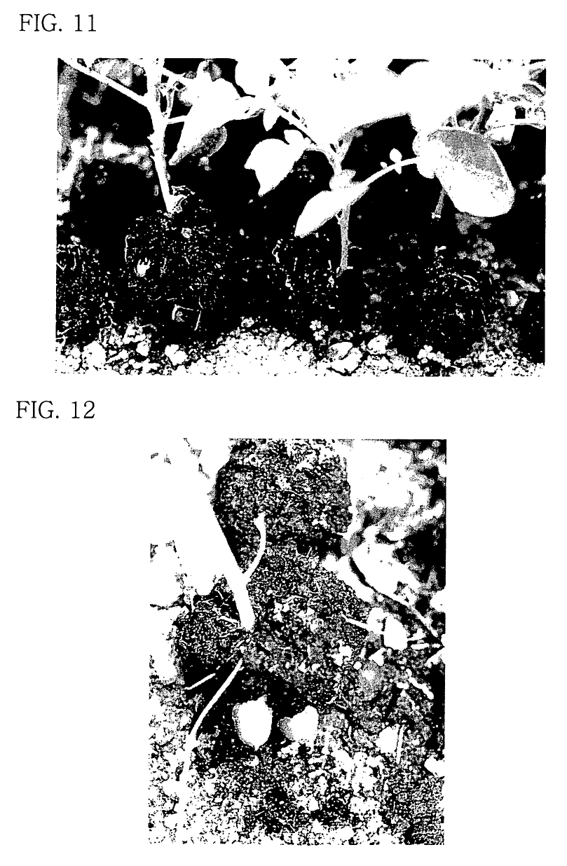

In the growth state of the bulbous plants pellets according to sowing method, in the case of Lilium tigrinum main bud, the pellets sown in the soil surface were more excellent in all respects, only leaf length of the pellet sown in the soil was a little excellent by 6.17 cm (Table 3). In the case of Lilium tigrinum main bud pellets, which were sown in the soil surface, showed more than two times in the leaf emergence rate (FIG. 1), an excellent the number of the leaf emergence after sowing (FIG. 3a, 3b, 3c, 3d, FIG. 8) and 4 days fast leaf emergence (FIG. 3c). In the case of potato, the growth differences according to the sowing method was almost similar, it is believed that the reason for this is because of nutrients stored within the potato. And the results indicate that it is possible to sow the potato seeds in the soil surface in practical cultivation (Table 4). The pellets of potato, which were sown in the soil surface, showed an excellence in germination rate (FIG. 2, FIG. 11), germination population after sowing and germinating day (FIG. 4a, 4b, 4c, 4d). These characteristics indicated that the pellets act as a sufficient substitute for soil and the oxygen necessary for germination and growth is supplied sufficiently by distinguished aeration of the peatmoss (FIG. 9, FIG. 12).

Comparing the growth of the bulbous plants pellets according to plant growth regulator treatment, the pellets of Lilium tigrinum main bud showed that the plant treated with GA was superior more than two times in all growth state than the plant treated with NAA (Table 3, Table 7). Moreover, leaf emergence rate of the plant treated with GA was higher and germinating day after sowing was faster (FIG. 1, 3c, 3d). In the case of the pellets of potato, the plant treated with GA showed two or three times excellent growth state in all respects (Table 4, Table 8). Also, leaf emergence rate was 40% higher and germinating day after sowing was 10 days faster, therefore treatment of GA showed more excellent effect than treatment of NAA (FIG. 2, 4c, 4d).

As a synthesis of the results presented above, the pelletization of bulbous plants according to the present invention improved the growth of seeds in terms of leaf emergence rate and germinating day after planting in the sowing in the soil surface and those treated with GA.

### INDUSTRIAL APPLICABILITY

As shown by the study, the pelletization method for bulbous plants according to the present invention, which consisted of mixing materials consisting of fertilizer, plant growth regulator with peatmoss, compressing and forming said mixture, inserting bulbous plants in it after drying and compressing, exhibited no problem with chemical reaction during the process. And the pellets of bulbous plants prepared through to this method prevents the physiological reaction of bulbous plants resulting from removal of water within the pellet, and therefore leaf emergence rate and the growth of the bulbous plants are remarkably excellent. In addition, the present invention makes bulbous plants to show a normal leaf emergence rate without requiring the covering of earth again after the seed has been sown in the soil surface. Accordingly, the present invention is an important development for industries involved in agriculture and gardening.

What is claimed is:

1. A pelletization method for bulbous plants comprising the steps of:
a) mixing one of more materials selected from a group consisting of fertilizer, plant growth regulator, bactericide and insecticide with peatmoss using water-soluble glue;
b) compressing and forming a pellet by dividing it into a lid and an entity to insert bulbous plants in that from the mixture prepared in Step a);
c) drying the pellet formed Step b); and
d) inserting the bulbous plants in the dried entity, covering them with the dried lid and compressing them to produce the resulting pellet with an inserted bulbous plants.

2. The pelletization method in claim 1 in which the bulbous plants are one selected from a group consisting of Lilium tigrinum main bud and potato.

3. A pellet of the bulbous plants prepared according to the method described in claim 1 containing any of the bulbous plants described in claim 2

4. A cultivation method for plants that involves the planting and germinating of the pellets of the bulbous plants described in claim 3.

5. The cultivation method for plants in claim 4, wherein it is treated in the soil surface without being covered with earth again after sowing.
